(19) United States
(12) Patent Application Publication
(10) Pub. No.: US 2017/0055724 A1
(43) Pub. Date: Mar. 2, 2017

(54) BED SAFETY DEVICE

(71) Applicant: Daniel ELDRIDGE, East Sussex (GB)

(72) Inventor: Daniel ELDRIDGE, East Sussex (GB)

(21) Appl. No.: 15/238,768

(22) Filed: Aug. 17, 2016

(30) Foreign Application Priority Data
Aug. 27, 2015 (GB) GB1515212.7

(51) Int. Cl. A47D 15/00; G08B 21/02

(52) U.S. Cl. CPC A47D 15/008; G08B 21/0277; G08B 21/0283

(57) ABSTRACT

The present invention relates to a bed safety device for positioning on a surface surrounding a bed. The bed safety device has a padded body that defines a continuous region and a means for locating the body with respect to the bed so that the continuous region surrounds the bed.

### FIELD OF THE INVENTION

The present invention relates to a bed safety device, in particular a device for safety with reference to falling from the bed; more particularly but not exclusively a device for infants.

### BACKGROUND

Increasing improvements in infant care mean that often infants can have bespoke beds. These beds often have elevated sides to prevent infants escaping the bed, or otherwise falling from them. Despite this, infants can be problematic in bedtime situations for example by trying to escape from their bed or by throwing toys from their bed.

It may be difficult to be aware of when the infant awakes, when they are supposed to be in their beds.

Some infants may be able to climb the elevated sides of their bed, for example depending on any discrepancy between the infant's capacity and height.

### PRIOR ART

Accordingly a number of patent applications have been filed in an attempt to resolve the problem or similar, including the following:

Korean patent application KR 20120 039 151 (LEE) discloses a baby bed provided to check situation of infant or kids in long distance on a real time basis. The baby bed comprises a mat, a fence, a sensing attitude tool, a proximity detection tool, a microphone, a wireless transmitting method, and a portable terminal.

US patent U.S. Pat. No. 6,594,835 (WEST) discloses a sensing means designed to activate an impact cushioning system for protecting an occupant of bed, gurney or examination table, from fall related injuries.

U.S. Pat. No. 2,608,696 (LE ROY) discloses a safety net attachment for a crib which has a drop side provided with openings therein, said safety net comprising a net a plurality of mounting means adapted to be mounted on the lower part of said drop side, a plurality of supports, each of which is secured at one end to one of said mounting means, each of said supports being vertically adjustable with respect to the mounting means.

### SUMMARY OF THE INVENTION

According to the present invention there is provided a bed safety device for positioning on a surface surrounding a bed comprising: a padded body that defines a continuous region and a means for locating the body with respect to the bed so that the continuous region surrounds the bed.

In this way a protective perimeter is provided around a bed so that if a bed user climbs or falls from their cot or bed they land on a padded surface. The padded body also protects any item dropped from the bed or cot.

The means for locating the body help to secure the body in position so that it does not move about in use.

Preferably the means for locating the body with respect to the bed may be in the form of a layer arranged within the circumference of the body upon which legs of the bed are received so as to fix the device in positing during use.

In this way the legs are arranged to be positioned upon the layer, and the body is arranged to abut the legs. The weight of the bed passed through the legs onto the layer serves to hold the bed safety device in place and ensure the body is correctly positioned around the bed.

In some embodiments the means for locating comprises or includes a tie for securing about a leg of the bed. The tie may be instead of or as well as the layer.

The ties may include a buckle, clasp, hook and loop means, magnets, press fitting or a toggle for securing the tie or ties together about the leg.

In some embodiments the bed safety device includes a base that is placed in contact with the surface upon which the device and bed are located in use.

The base may be in the form of an additional layer or coating so as to help secure the device in place, preventing it from slipping and in some cases to compensate for an uneven surface.

For example the base may be a resiliently deformable layer such as a rubber mat or a textured coating such as a textured paint.

The base may be integrated with the body or attached to the body. In some embodiments the base may also be attached to the means for locating the bed.

Advantageously the base may also serve as a protective layer for the body.

In a preferred embodiment the body is inflatable. Advantageously this enables the bed safety device to be stored compactly when not in use.

Preferably the inflatable body comprises a plurality of independently inflatable cells. In this way the device can remain functional even if one cell becomes puncture.

In some embodiments the cells may include internal ties such as those provided in a lilo or air mattress to provide improved strength and to prevent air being forced to one region when force is applied to the cell.

The plurality of inflatable cells are arranged in a sequential configuration to describe a continuous circumference around a bed, the cells are configured to each be inflated independently.

In other embodiments the body is formed from a padded material, for example a cellular structure such as foam, or a fibrous material, or resiliently deformable material such as rubber.

In some embodiments the body may be formed from a combination of padded materials and inflatable cells.

In preferred embodiments the bed safety device includes at least one sensor for detecting impact or pressure applied to the body. In this way the safety device monitors any contact with any part of the body, such as a bed user such as a child or infant leaving their bed or dropping an item from their bed.

The sensor may comprise without limitation an impact sensor, a vibration sensor, a pressure sensor, or a displacement sensor. Such sensor(s) register impact on the device or a part of the device or measure a change in pressure within the body, for example in one of the inflatable cells.

It is appreciated that the bed safety device may be for adult, child or infant use. For example the device may help monitor a known sleepwalker or vulnerable adult.

Preferably the activation of the sensor causes a signal to be transmitted to an alert means to generate an alarm. Communication between the sensor and the alert means enables an alert to be triggered that serves to advise a designated person, such as a parent, guardian or carer of the movement detected on the body of the bed safety device.

In some embodiments the alert means are integrated with the body and/or sensor.

Preferably the alert means are remote from the body so that activation of the sensor causes a signal to be transmitted wirelessly to the remote alert means in order that the alert is raised at a location remote from the bed.

The sensor and alert means may communicate wirelessly by Bluetooth®, radio frequency (RF) or through a telecommunication network.

Typically the alert means transmits an alarm signal to a location remote from the body so that activation of the sensor causes a signal to be received at a remote receiver which in turn emits an alarm.

It is appreciated that in some embodiments the sensor and the alert means may be hard wired together.

In this way the designated person can be instantly alerted to movement of, or caused by, an adult, child or infant. Once alerted the designated person can then observe and assist immediately minimising distress and possible injury, if, for example, a child tried to escape their cot in order to retrieve a toy that had been thrown from the cot.

The alert means includes either, or a combination of, an audible, visual or vibrating alert.

Preferably the alert means may comprise an electronic device capable of receiving the signal(s) transmitted from the sensor and activating an alarm on the electronic device upon receipt of the signal. For example the alert means may be a smartphone, baby monitor, fob or pager.

Advantageously in some embodiments the electronic device may enable changing and activation of settings for the bed safety device. For example a designated user may be able to select the type of alarm emitted or to turn on or off an active light source.

In some embodiments a local alert means may be included in addition or as an alternative to the remote alert.

Preferably the alarm may only be turned off locally, at the device to ensure the pressure detected is investigated. In this way the user is required to observe the bed safety device and check on the user of the bed.

The safety device with at least one sensor includes a power supply. Preferably the power source is a battery and preferably a rechargeable battery.

In some embodiments the power source is a mains electrical supply. For example the device may include a socket for receiving an electrical cable.

In some embodiments the device may include photovoltaic cells to charge the battery(ies).

In some preferred embodiments the bed safety device includes a light source to illuminate some or all of the body.

The light source may comprise a passive light source such as retroreflective, fluorescent or luminescent portions, or any combination of the before mentioned passive light sources.

In some embodiments the light source may comprise an active light source, so as to advantageously provide a strong illumination means that draws attention to the device, and may function as a night light for an infant in the bed.

The light source may be provided by at least one light emitting diode. Advantageously such illumination means enables the device to be effectively and safely illuminated at all times.

In some embodiments the light source may comprise a combination of passive and active lighting.

Ideally the light source is provided to light some or all of the body. For example in some embodiments only part of each inflatable cell may be lit.

The light source may be used to alert parents, carers or users, to the presence of the device.

In some embodiments the body may become lit upon detection of pressure applied to the body or presence of a person approaching the body. For example activation of a sensor causes a signal to be sent to activate the light source.

In some embodiments the device may include a timer so that the active light source is active a pre-selected times. For example during the hours of darkness.

In some embodiments the body may be lit in a different colour when a pressure is detected to distinguish this from the light source used to illuminate the body for the purposes of advising a user of the body's presence.

In this way a designated person can readily observe if anything has come into contact with the body of the device.

In some embodiments the light source is directed to illuminate an interior of the body so that the body glows.

For example in some embodiments the body is from a luminous material or part of the body is formed from a luminous material.

In some embodiments the body may include a retroreflective portion or is comprised from a retroreflective material.

The light source may comprise a combination of the above described examples.

Preferably the bed safety device has a wipe clean outer surface so that the device can easily be cleaned. For example the body may be formed from a synthetic plastic.

In preferred embodiments an outer upper face of the bed safety device is decorated. For example the device may be decorated with images or text that appeals to children, such as cartoon characters.

In some embodiments the bed safety device may be provided with a bag so that when not in use the device can be stowed.

Preferred embodiments of the invention will now be described, by way of example and with reference to the Figures in which:

### BRIEF DESCRIPTION OF FIGURES

FIG. 1 shows an isometric view of an embodiment of the device according to the present invention;

FIG. 2 shows a reverse isometric view of a second embodiment;

FIG. 3 shows a reverse isometric view of a third embodiment, with 3 cells collapsed;

FIG. 4 shows an isometric view of the embodiment shown in FIG. 3, with 3 cells collapsed;

FIG. 5 shows a second isometric view of the embodiment shown in FIG. 1;

FIG. 6 shows a plan sketch view of an embodiment of the device according to the present invention; and

FIG. 7 shows a sketch of an isometric view of an embodiment of the device shown in FIG. 6, in use.

### DETAILED DESCRIPTION OF FIGURES

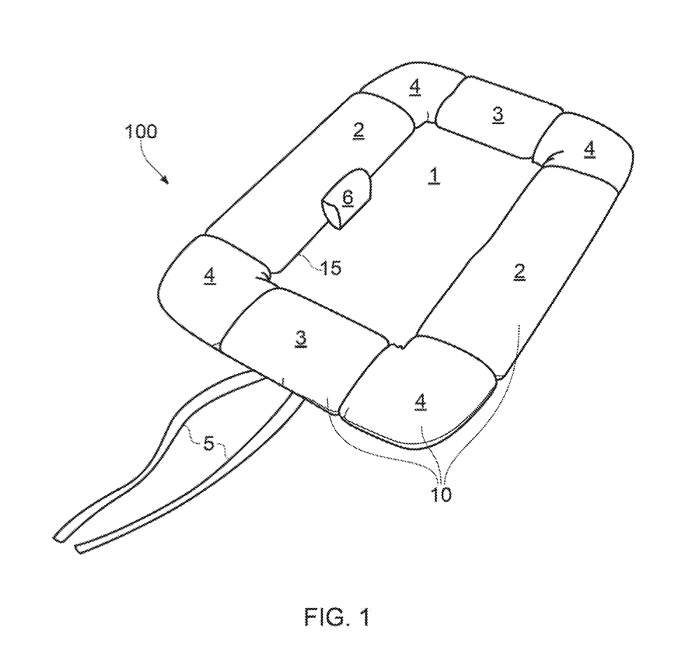

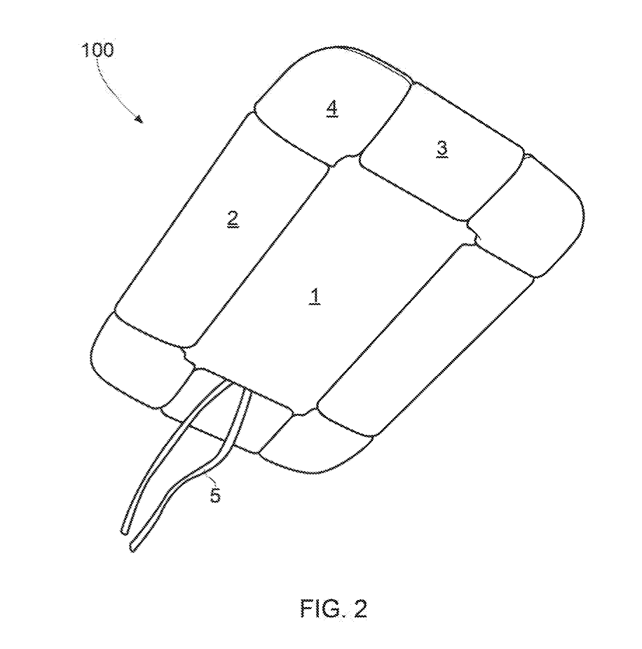

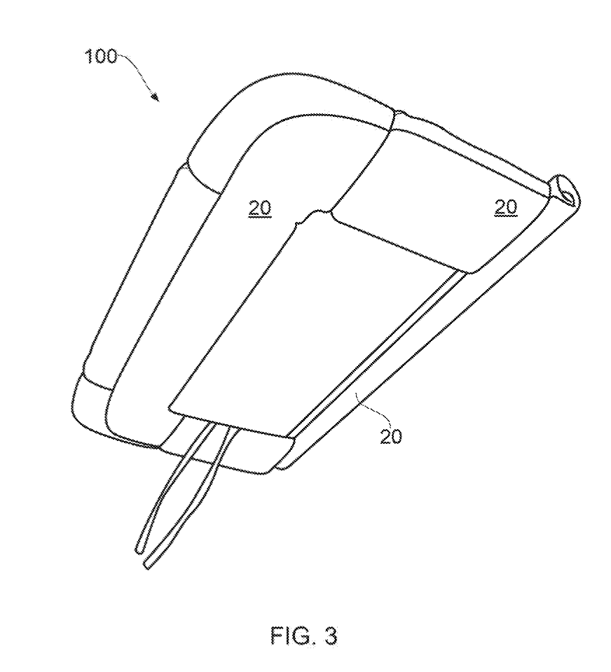

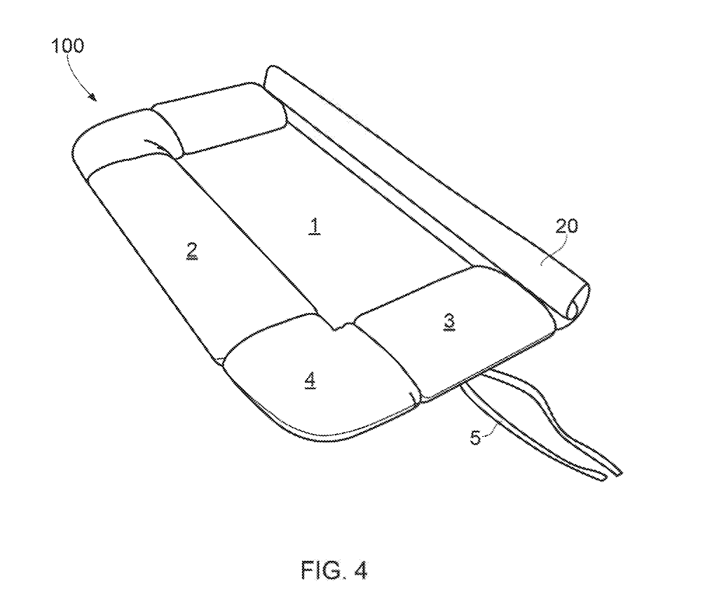

FIGS. 1 to 7 show a preferred embodiment of the bed safety device 100.

The bed safety device 100 has a plurality of perimetric cells 2, 3, 4 forming a body 10.

The body 10 surrounds a means for locating the bed 1. The means for locating the bed 1 is a rectangular, planar central layer 1.

The cells 2, 3, 4 are padded so as to be soft. In this embodiment the cells 2, 3, 4 are inflatable.

The bed safety device 100 may provide or include a base 20, provided on an underside of the bed safety device that come into contact with the surface upon which the bed safety device 100 is positioned in use.

The base 20 allows for uneven, slippery or damp surfaces, and/or may allow for rolling of a side. The base may be comprised from more than one layer.

The base 20 may comprise attachment means, may be displaceable or may be a coating or flap.

Advantageously the means for locating the bed is placed in use under the bed or cot, so as to prevent movement of the bed safety device 100, and maximise its effectiveness. In this way the legs of the bed (such as a cot) are located upon the means for locating the bed such that the legs abut the cells.

The means for locating the bed 1 are dimensioned to correspond to the bed on which the safety device will be used.

In some embodiments the centre may be empty and instead other securing means such as ties may be provided to for locating the bed. Advantageously this permits easy location of the device into use.

The bed safety device 100 is rectangular having a padded body formed from 8 cells 2, 3, 4.

The padded body has four corner cells 4, two parallel long cells 2 and two parallel short cells 3 so as to define a perimeter around the bed in use.

Preferably each cell is separately inflatable so that a puncture does not result in the deflation of the entire body of the bed safety device. Advantageously this enables fast and easy inflation of each cell.

In some embodiments each cell may include sub-cells to provide residual inflation if the cell is punctured.

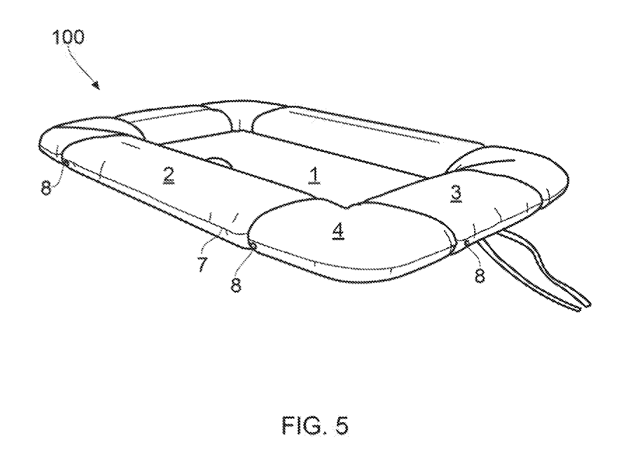

The cells are formed from a synthetic plastic with a peripheral seam 7 (FIG. 5), and an internal seam 15 (FIG. 1). This internal seam 15 is located midway on the cell side, so as to place the cell structure under tension when the device is in use.

Each cell includes an inflation point (not shown). Preferably the inflation point is in the form of a one-way valve to make inflation easier. In other embodiments further inflation valves or means may be envisaged.

In some embodiments self-inflation may be preferred in part or whole, for example wherein release of a valve enables intake of air to inflate the cells. In this way uninflated cells may be easily kept rolled when not inflated and inflation may be quick and largely effortless for the user.

In some embodiments the cells are connectable, for example wherein the device comprises a temporary cell connection means such as hook and loop material (like Velcro®. This may limit chances of an infant falling between cells.

Furthermore in some embodiments the cells 2, 3, 4 may be displaceable so that they can be arranged in the desired orientation about a bed to allow for variations in bed size, location of bed legs or other objections near to the bed.

Typically the cells include attachment means such as hook and loop means to permit connection of the cells to each other and/or the base and/or means for locating. In this way one bed safety device may be suitable for use on different beds.

If a cell is not inflated the cell structure may be collapsed, folded, rolled or otherwise so that it is displaced whilst not in use.

The bed safety device includes laces 5, which extend out from the means for locating 1 to enable the device to be rolled up and secured in the rolled configuration. In some embodiments laces 5 may be arranged to all and every side, or cell, so as to allow neat capture of rolled cells.

In FIG. 1 there is shown a unit 6 that is capable of emitting an audible alarm. The alarm is triggered when a sensor (not shown) detects a presence on the body.

The unit 6 includes a receiver for detecting a signal from a sensor and a microprocessor for processing the signal and generating an alert.

The unit 6 may also contain a transceiver to allow a signal to be transmitted from the unit 6 to a remote receiver in order to activate a remote alarm. I this way a user can be alerted at a different location, for example a parent in a different room.

The unit 6 is maintained in a pocket so as to prevent ingress of moisture or liquid. In some embodiments the pocket may be located on any cell, or each.

The unit 6 is situated on an internal face of a cell 2, and may therefore be envisaged to be protected from impact damage by the cell when inflated. Advantageously therefore a falling infant will be unlikely to cause themselves any injury if they are to fall from their bed.

The unit 6 can be removed from the bed safety device 100 so that it can be readily maintained or repaired.

In some further embodiments the unit may be positioned so as to be under the bed.

The unit may include a wired connection, or connection point in the form of a socket which connection permits mains electrical powering of the unit 6.

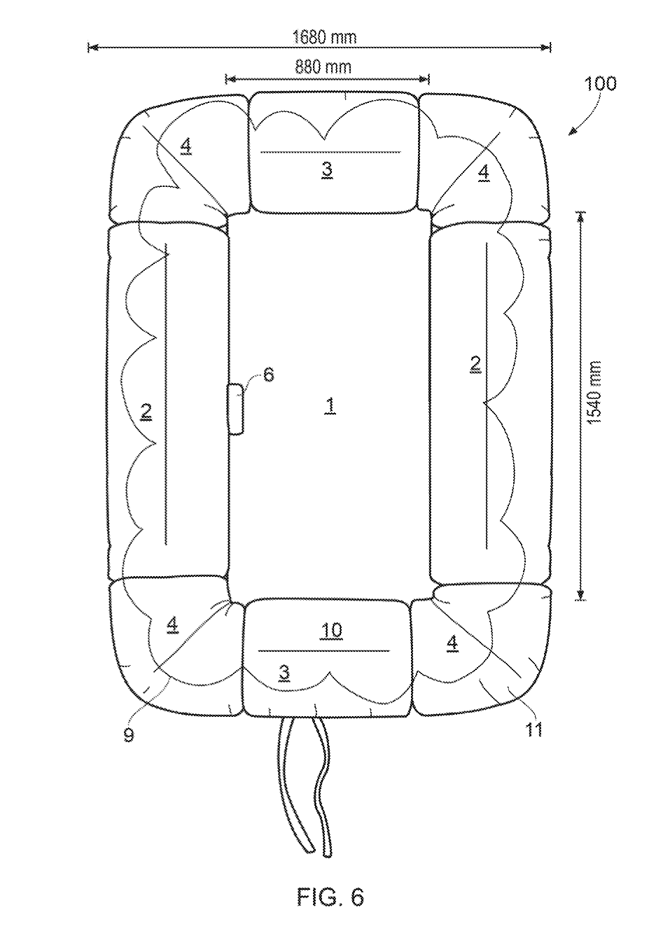

With reference to the embodiment shown in FIG. 6, the cells include variegated colouring, namely a darker outer 11, lighter inner 10 having a luminous outline 9. In this way a carer attention is drawn to the presence of the device.

In the pictured embodiment the outline and variegation describes a cloud shape, to provide a reassuring form to an infant.

The luminosity may be provided by any combination of the following: fluorescent, retroreflective, luminescent coating, or a powered lighting solution. In some embodiments the luminosity may act as a comfort light for an infant in the bed.

In some embodiments the outer or inner may be luminous in addition or the alternative.

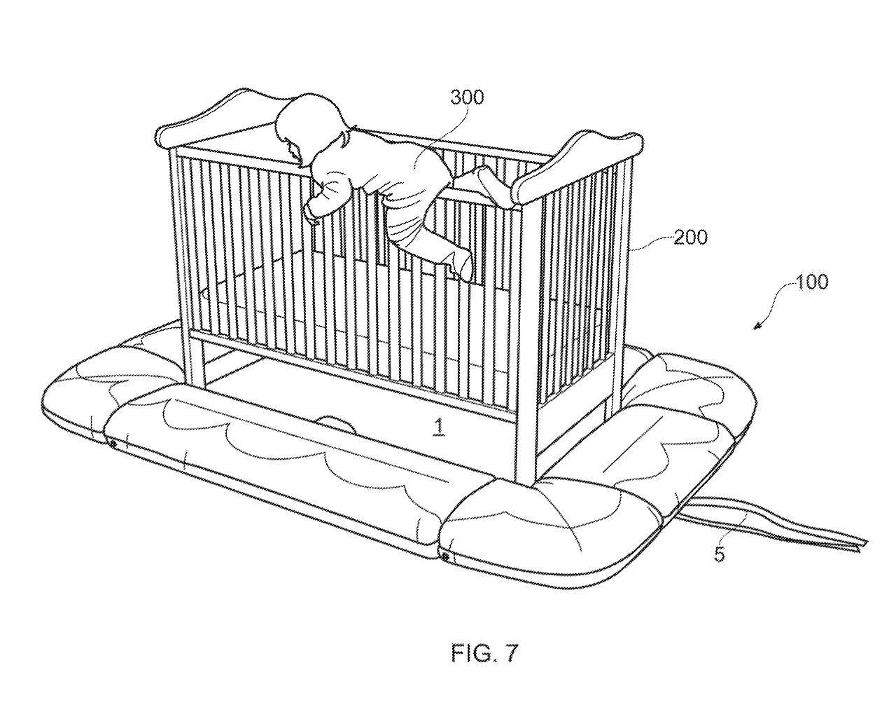

FIG. 7 shows an overview of the bed safety device 100 in use, with a cot 200 arranged on top of the central layer 1. An infant 300 is shown climbing from the cot 200.

Ties 5 are provided to secure the bed safety device 100 in a rolled or folded configuration when not in use.

The invention has been described by way of examples only and it will be appreciated that variation may be made to the above-mentioned embodiments without departing from the scope of invention as define by the claims.

1. A bed safety device for positioning on a surface surrounding a bed comprising: a padded body that defines a continuous region and a means for locating the body with respect to the bed so that the continuous region surrounds the bed.

2. A bed safety device according to claim 1 wherein the means for locating comprises a recess defined by the continuous region in which legs of the bed are received so as to locate the device with respect to the bed.

3. A bed safety device according to claim 1 wherein the means for locating includes a tie for securing about a leg of the bed.

4. A bed safety device according to claim 1 wherein the body is inflatable.

5. A bed safety device according to claim 4 wherein the body comprises a plurality of independently inflatable cells.

6. A bed safety device according to claim 1 includes at least one sensor for detecting impact or pressure applied to the body.

7. A bed safety device according to claim 6 including an alert means wherein activation of the sensor generates an alarm.

8. A bed safety device according to claim 7 wherein the alert means transmits an alarm signal to a location remote from the body so that activation of the sensor causes a signal to be received at a remote receiver which in turn emits an alarm.

9. A bed safety device according to claim 8 wherein the sensor and alert means are capable of communication.

10. A bed safety device according to claim 7 wherein the alarm is generated by at least one of: an audible device; and a visual device; and a vibrating device.

11. A bed safety device according to claim 7 includes a power supply which is a battery.

12. A bed safety device according to claim 7 includes a power supply which is a mains electrical supply.

13. A bed safety device according to claim 1 includes a light source.

14. A bed safety device according to claim 13 in which the light source is directed to illuminate an interior of the body.

15. A bed safety device according to claim 1 wherein the body is formed from a luminous material.

16. A bed safety device according to claim 1 wherein the body includes a retroreflective portion or is comprised from a reflective material.
